(19) United States
(12) Patent Application Publication
(10) Pub. No.: US 2013/0250551 A1
(43) Pub. Date: Sep. 26, 2013

(54) DISPLAY DEVICE HAVING A TRANSPARENT BODY

(71) Applicant: Sandro Schneider, Thalwil (CH)

(72) Inventor: Sandro Schneider, Thalwil (CH)

(73) Assignee: MB-MICROTEC AG, Niederwangen bei Bern (CH)

(21) Appl. No.: 13/989,946

(22) PCT Filed: Dec. 20, 2011
(86) PCT No.: PCT/EP2011/073433

§ 371 Date: May 28, 2013

(30) Foreign Application Priority Data
Dec. 20, 2010 (AT) A2097/2010

(51) Int. Cl. F21V 7/00

(52) U.S. Cl. CPC F21V 7/0091
USPC 362/97.1

(57) ABSTRACT

Display device (1) having a transparent body (2), with the display device (1) having a self-contained, self-illuminating light source (3), characterized in that the light source (3) is embedded in the transparent body (2), with light emitted by the light source (3) being retained in the transparent body (2) by total internal reflection at the boundary surfaces (4, 5, 6, 7) of the transparent body (2) and the transparent body (2) further comprises at least one light output side (8) having at least one light output structure, formed by at least one elevation (9) and/or at least one recess (10) in a surface of the transparent body (2), for outputting light of the self-illuminating light source (3).

The invention relates to a display device having a transparent body, with the display device having a self-contained, self-illuminating light source.

Furthermore, the invention relates to a timepiece having a clock face and a transparent cover covering the clock face.

Document U.S. Pat. No. 3,701,900 describes a device for illuminating flat carriers by means of a radioactive light source, suitable for reading in darkness, for example. This radioactive light source shines onto the carrier made of transparent material. Examples for carriers are dials, perforated disks, dial plates and clock faces. The emitted light disperses within the transparent material due to total reflection, with marks opposite a light output side being provided for output of light from the body. The light source used is embodied to be annular and laterally arranged around the carrier.

One disadvantage of the known embodiment is the relatively expensive production due to the annular embodiment of the light source. A further disadvantage is that the light input is performed via the end faces of the glass cover, i.e. via the edge, resulting in a relatively weak illumination. It is furthermore disadvantageous that the marking is arranged on a side opposite a light output side and thus, an undefined diffusion of light results.

It is therefore the objective of the underlying invention to allow a good light efficiency and an optimal illumination of an information carrier at an easiest design possible.

According to the invention the above-mentioned objective is achieved by using a display device of the above-mentioned kind and due to the fact that the light source is embedded in the transparent body, with light emitted by the light source being retained in the body by total internal reflection at boundary surfaces of the transparent body and the transparent body further comprising at least one light output side having at least one light output structure, formed by at least one elevation and/or at least one recess and/or at least one roughened region in the surface of the transparent body, for outputting light of the self-illuminating light source.

An advantageous embodiment is that the light source of the display device is completely embedded in the transparent body. This embodiment of the invention is particularly suitable for illuminating books, e-books etc., as the light source is particularly well protected.

An embodiment of the invention allowing the display device to be adapted to different lighting requirements provides that the self-illuminating light source of the display device is embodied to be punctiform, rod-shaped or plate-shaped.

According to a further embodiment of the invention it may be provided that the transparent body wherein the light source of the display device is embedded is embodied to be plate- or saucer-shaped. In the event of a plate-shaped embodiment, the plate can be simply integrated into existing devices like a timepiece, and planar display devices. If the transparent body is embodied to be saucer-shaped, the display device can be used as a cover for a watch or timepiece.

An advantageous embodiment of the invention is that the light output structure of the display device is embodied as a groove. This groove can be designed to have the shape of an image or character to be displayed. A particularly advantageous output of the light and thus a clear illustration of the pictogram or character is thereby effected. Furthermore, with watches, for example, a clock face to be illuminated can be omitted.

According to another advantageous embodiment it can be provided that a surface of the transparent body which surface is opposite the light output side and essentially runs parallel with the light output side is embodied to be flat. This design is very well suitable for illuminating a print medium or an c-book.

According to the invention, the above-mentioned objective can also be achieved by a watch of the above-mentioned kind and due to the fact that above or below the clock face a display device according to one of claims 1 to 7 is situated or the clock face is formed by a display device according to one of claims 1 to 7.

The above-mentioned form of embodiment allows a particularly simple design of a self-illuminating clock face or a permanent clock face illumination having a minimal number of self-illuminating light sources to be realized.

An advantageous further embodiment of the timepiece according to the invention resides in the fact that the light output side faces the display device of the transparent cover, so that the light of the self-illuminating light source leaves the timepiece against the direction of view. Thereby, a particularly good light efficiency and efficient lighting of the timepiece can be achieved.

According to another advantageous embodiment of the timepiece according to the invention it can be provided that the display device is at least arranged below a date display, with the date display being formed from a partially translucent mask. Therefrom results a very simple and cost-efficiently realizable embodiment of a timepiece having an optimal lighting of the clock face.

According to another embodiment of the timepiece according to the invention, the cover of the timepiece can be formed from a display device according to the invention. This embodiment has also the advantage that an own clock face in the interior of the timepiece can be omitted, if the digits are shown by means of the display device. The embodiment according to the invention is additionally well suitable to be used for illuminating an information carrier disposed on the side of the light output side, in particular a printed matter or an e-book. Therefrom results a cost-efficient constant lighting of printed matters and e-books, which lighting is independent of energy.

The invention including further advantages will be explained below by means of non-restricting examples illustrated in the appended drawings.

The heavily simplified schematics show:

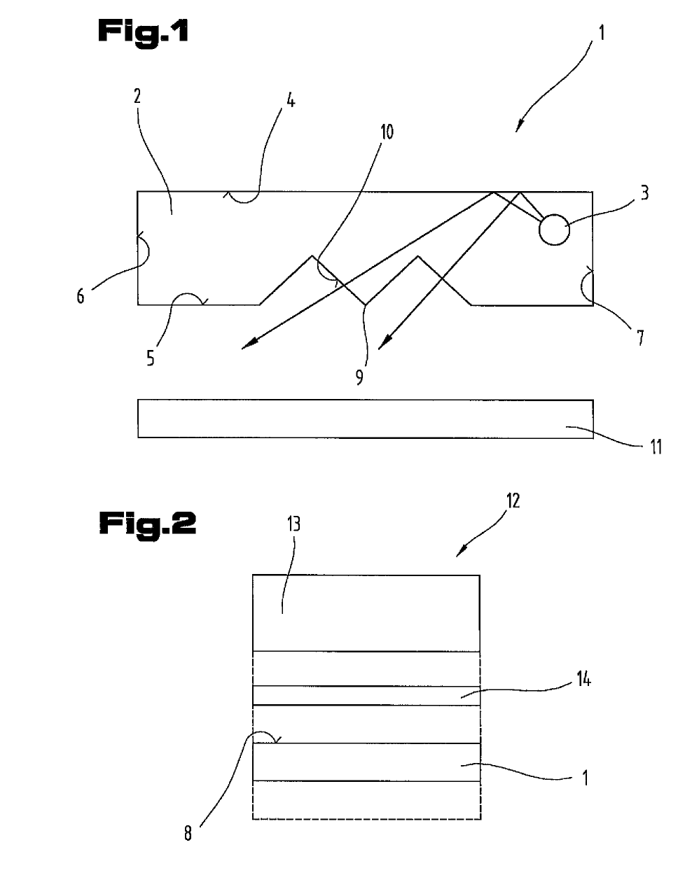

FIG. 1 a display device according to the invention

FIG. 2 an exemplary design of a first variant of a timepiece according to the invention having a display device from FIG. 1

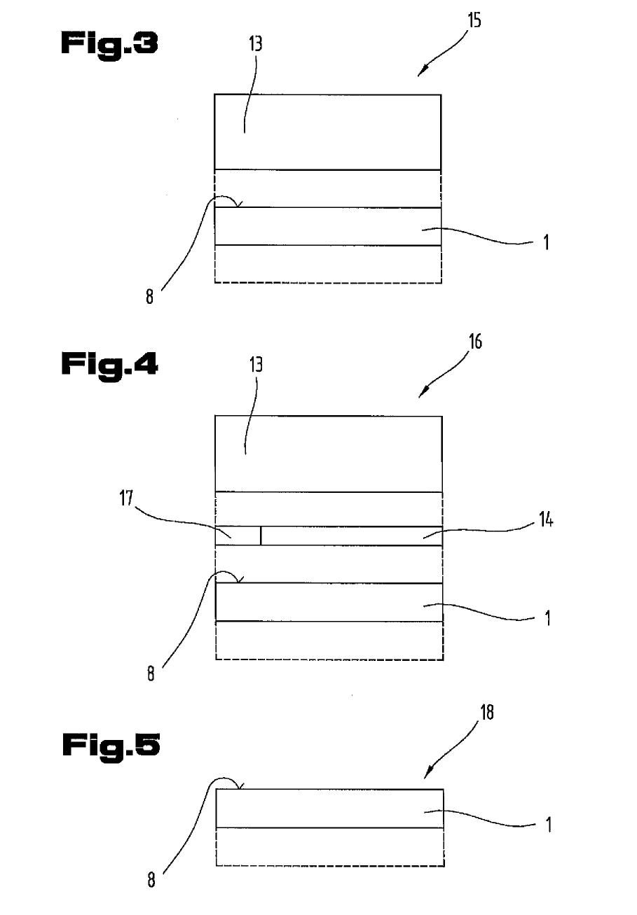

FIG. 3 an exemplary design of a second variant of a timepiece according to the invention having a display device from FIG. 1

FIG. 4 an exemplary design of a third variant of a timepiece according to the invention having a display device from FIG. 1

FIG. 5 an exemplary design of a fourth variant of a timepiece according to the invention having a display device from FIG. 1

Firstly, it should be pointed out that the same parts described in the different embodiments are denoted by the same reference numbers and the same component names and the disclosures made throughout the description can be transposed in terms of meaning to same parts bearing the same reference numbers or same component names Furthermore, the positions chosen for the purposes of the description, such as top, bottom, side, etc., relate to the drawing specifically being described and can be transposed in terms of meaning to a new position when another position is being described. Individual features or combinations of features from the different embodiments illustrated and described may be construed as independent inventive solutions or solutions proposed by the invention in their own right.

According to FIG. 1, a display device according to the invention has a transparent body 2 as well as a self-contained self-illuminating light source 3. The light source is embedded in the transparent body 2. The light source 3 is preferably completely embedded in the transparent body 2, so that it is held within the latter in a captive way. Depending on the requirements it is possible for the light source 3 to be embodied to be punctiform, rod-shaped or plate-shaped. According to the preferred embodiment of the invention, the light source is embodied as a tritium gas light source. Such light sources have been known under the name trigalight.

Light emitted by the light source 3 is kept in the body 2 by total reflection at boundary surfaces 4, 5, 6, 7 of the transparent body 2. Furthermore, the transparent body 2 has a light output side 8 having one or more light output structures for outputting light out of the transparent body 2. The light output structure may be formed by an elevation 9 and/or a depression 10 in the surface of the transparent body 2. The elevation 9 and the depression 10 can form a groove, which may also have the structure of a pictogram or character to be displayed. In this case, it is also possible for the groove to be filled up with a transparent, probably dyed glue. After its curing, this glue can end flush with the surfaces of the body 2 adjacent to edges of the grooves and without forming a transitional level, so that a continuous surface of the transparent body 2 not being broken by the groove results. Due to the different refractive indices of glue and the transparent body 2 that may be made of glass or plastic, an optically three-dimensional impression of the pictograms or characters may be achieved.

According to another embodiment of the invention, it is also possible for the light output structures to be realized by roughening the surface.

The transparent body 2 can, as shown in FIG. 1, be embodied to be plate-shaped but also to be saucer-shaped. The plate-shaped embodiment has the advantage that it can be mainly used for lighting an e-book reader. It is in this context also preferable if a surface of the transparent body 2, disposed opposite the light output side and essentially extending parallel with the light output side 8, is embodied to be smooth.

A saucer-shaped embodiment of the transparent body 2 can for example be advantageous when the display device is used as a cover for a timepiece.

The display device according to the invention may also be used for lighting an information carrier 11, such as a printed matter or an e-book, disposed on the side of the light output side.

According to FIG. 2, a timepiece 12 according to the invention has a clock face 14 and a transparent cover 13 covering the clock face 14—a watch glass. Above or below the clock face 14, a display device 1 according to the invention can be arranged. As shown in FIGS. 3 and 5, it is also possible for the clock face 14 of a timepiece 18 to be formed from a display device 1 according to the invention.

In the embodiment according to FIG. 3, another cover 13 is provided above the clock face or the display device 1. Whereas, with the embodiment of the timepiece 18 according to the invention as shown in FIG. 5, both, the clock face 14 and the cover 13 may be formed by the display device. For the variants of the embodiment shown in FIGS. 3 and 5 it is particular advantageous if a display device 1 is used, which is equipped with the characters or pictograms to be presented, in particular the numbers provided for displaying the time in the form of depressions or grooves. Those depressions or grooves can, as stated above, be filled up by means of a translucent or transparent glue. After the glue is cured, it is possible for the display device 1 to have a smooth surface across the entire light output side 8.

As it can be taken from the FIGS. 2 to 4, the light output side 8 of the display device 1 can face the transparent cover 13 of the timepiece 12, 15, 16.

The display device 1 of the embodiment of the timepiece 16 according to the invention shown in FIG. 4 can be arranged below the clock face 14, which can in this case be made of a mask having translucent and light-tight areas. The light output side 8 of the display device can in this case face the clock face 14 in order to achieve a maximum luminous efficiency and an optimal lighting.

According to another variant of the invention it can nevertheless also be provided that the display device according to the invention is only used to illuminate a date display 17. In this case, the display device 1 can at least be arranged below the date display 17. Also the date display 17 can e.g. be formed from a partially translucent mask.

The embodiments illustrated as examples represent possible design variants, and it should be pointed out at this stage that the invention is not specifically limited to the design variants specifically illustrated, and instead the individual design variants may be used in different combinations with one another and these possible variations lie within the reach of the person skilled in this technical field given the disclosed technical teaching. Accordingly, all conceivable design variants which can be obtained by combining individual details of the design variants described and illustrated are possible and fall within the scope of the invention.

### LIST OF REFERENCE NUMERALS

1 Display device
2 Transparent body
3 Light source
4 Boundary surface
5 Boundary surface
6 Boundary surface
7 Boundary surface
8 Light output side
9 Elevation
10 Recess
11 Information carrier
12 Timepiece
13 Transparent cover
14 Clock face
15 Timepiece
16 Timepiece
17 Date display
18 Timepiece

1-13. (canceled)

14. Display device (1) having a transparent body (2), with the display device (1) having light source (3) embedded in the transparent body (2), and with light emitted by the light source (3) being retained in the transparent body (2) by total internal reflection at the boundary surfaces (4, 5, 6, 7) of the transparent body (2) and the transparent body (2) further comprises at least one light output side (8) having at least one light output structure, formed by at least one elevation (9) and/or at least one recess (10) in a surface of the transparent body (2), for outputting light of the light source (3), wherein the light source (3) is self-contained, self-illuminating and completely embedded in the transparent body (2).

15. Display device according to claim 14, wherein the self-illuminating light source (3) is designed to be punctiform, rod-shaped or plate-shaped.

16. Display devices according to claim 14, wherein the transparent body (2) is designed to be plate-shaped or saucer-shaped.

17. Display device according to claim 14, wherein the light output structure is embodied as a groove.

18. Display device according to claim 17, wherein the groove has the shape of a pictogram or character to be displayed.

19. Display device according to claim 14, wherein a surface opposite the light output side and essentially running parallel with the light output side of the transparent body (2) is embodied to be smooth.

20. Timepiece (12, 15, 16, 18) having a clock face (14) and a transparent cover (13) covering the clock face (14), wherein above or below the clock face (14), a display device (1) according to claim 14 is arranged or the clock face (14) is formed by the display device (1).

21. Timepiece according to claim 20, wherein the light output side (8) of the display device (1) faces the transparent cover (13).

22. Timepiece (19) according to claim 20, wherein the display device (1) is disposed below the clock face (12) and the clock face (12) is designed as a partially translucent mask.

23. Timepiece according to claim 20, wherein the display device is disposed at least below a date display (17), with the date display (17) being formed from a partially translucent mask.

24. Timepiece according to claim 20, wherein the cover (13) is formed from a display device (1) having a transparent body (2), with the display device (1) having light source (3) embedded in the transparent body (2), and with light emitted by the light source (3) being retained in the transparent body (2) by total internal reflection at the boundary surfaces (4, 5, 6, 7) of the transparent body (2) and the transparent body (2) further comprises at least one light output side (8) having at least one light output structure, formed by at least one elevation (9) and/or at least one recess (10) in a surface of the transparent body (2), for outputting light of the light source (3), wherein the light source (3) is self-contained, self-illuminating and completely embedded in the transparent body.

25. Use of a display device according to claim 14, for illuminating an information carrier (11) arranged on the side of the light output side (8), in particular a printed matter or an e-book.
